(19) United States
(12) Patent Application Publication
(10) Pub. No.: US 2004/0074397 A1
(43) Pub. Date: Apr. 22, 2004

(54) Kettle corn popper

(76) Inventor: John C. Calhoun, Alliance, OH (US)

Correspondence Address: LITTMAN LAW OFFICES, LTD., P.O. BOX 15035 CRYSTAL CITY STATION, ARLINGTON, VA, 22215, US

(21) Appl. No.: 10/277,190

(22) Filed: Oct. 22, 2002

(51) Int. Cl. A23L 1/18

(52) U.S. Cl. 99/323.5

(57) ABSTRACT

A kettle corn popper comprises a cabinet, a deck attached to an upper edge of the cabinet by a hinge, a hemispherical kettle fixed to the deck and protruding through the deck into the cabinet, a control panel attached to the cabinet, and heating assembly attached inside the cabinet.

### BACKGROUND OF THE INVENTION

1. Field of the Invention

The present invention relates generally to popcorn poppers and more specifically to kettle corn poppers.

2. Description of the Related Art

Popcorn and popcorn poppers have been around for years. Popcorn is especially popular at public events, such as fairs and carnivals. The sights, smells and sounds (to say nothing of taste) of the popcorn have an undeniable appeal. Part of the allure of popcorn in these public settings is the vendor's chosen method of popping the popcorn. At home, people typically use a small popper, and many of these small poppers have automatic features, such as self agitation and buttering. However, the typical commercial equipment found at carnivals, fairs, stadiums, etc., is different.

The commercial popcorn popping equipment is different because the demands upon the popcorn vendors are different. At many fairs, carnivals and other public events, there is a great demand for popcorn, so it is sensible for the vendor to make popcorn in large quantities. Thus typical popcorn poppers are larger in such settings. In addition, automatic agitation frequently is shunned, giving way to the showmanship of manual agitation, often with a large paddle resembling a boat oar. Another reason popcorn popping equipment is different in such public settings is due to the principle of supply and demand. The customers demand something different from what they can make in their own homes. Further, there is also an interest in a taste of the past, and popcorn made the old-fashioned way has a strong appeal. However, even the old-fashioned way must yield to some modern improvements.

When made the old-fashioned way, a batch of popped popcorn will have a large number of unpopped kernels and burned pieces. When ingredients other than simple popcorn and oil are used, such as sugar, those undesirable effects are magnified. This is unappealing and should be controlled to minimize waste and improve yield.

Another improvement is the choice of heat source. The days of popping large quantities of popcorn over an open fire are gone. It is far too inefficient and hazardous. Today, gas or electric heat are the primary choices. Gas, such as propane, is popular because it is a portable and reasonably safe energy source, and it requires no extension cords. However, the popping process is still an art and sometimes difficult to control properly. What is needed is a way to accurately monitor, adjust and control the popping process.

U.S. Pat. No. 5,555,792, issued to Stein et al. In September 1996, discloses a corn popping kettle assembly. However, it does not include any control instrumentation.

U.S. Pat. No. 5,857,403, issued to Mann in January 1999, discloses a corn popping apparatus with a kettle assembly. However, it does not include a control panel or gauges.

U.S. Pat. No. 6,032,572, issued to Mann in March 2000, discloses a corn popping apparatus with a kettle assembly. However, it does not include control instrumentation or an internal lifting mechanism.

U.S. Pat. No. 6,082,248, issued to Turrel in July 2000, discloses a portable heat-concentrating kettle cooker. However, it does not include a control panel, gauges, or an internal lifting mechanism.

U.S. Pat. No. 6,220,148 B1, issued to Pearce et al., in April 2001, discloses a kettle type corn popper. However, it does not include a control panel or gauges.

What is needed is a large-quantity popcorn popper that retains the operation methods of old-fashioned popcorn poppers, but includes modern monitoring and control equipment to improve the popcorn's quality and consistency, and makes it easier to clean and maintain.

None of the above inventions and patents, taken either singularly or in combination, is seen to describe the instant invention as claimed. Thus a kettle corn popper solving the aforementioned problems is desired.

### SUMMARY OF THE INVENTION

The device is a popcorn popper, more specifically a kettle corn popper which includes a cabinet with a large nonstick kettle for popping a large quantity of popcorn in a single batch, and that incorporates a plurality of control and monitoring instruments.

The cabinet comprises a generally rectangular box with a front, a back, two sides, an open bottom and a hinged deck lid on top. The deck lid comprises a large, hemispherical popping kettle. The popping kettle includes a nonstick surface and a cutaway lip along a small segment of an edge to permit the user to gain easier access to the popping kettle. The cabinet further comprises a multi-function control panel and an internal deck lid lifting mechanism, which also may limit the travel of the deck lid.

The multi-function control panel includes instrumentation for measuring, monitoring and controlling several parameters of the kettle corn popper, including temperature inside the cabinet, fuel pressure before a pressure regulator, fuel pressure after the pressure regulator, an electronic fuel igniter, a fuel shutoff valve, a fuel pressure control valve and a quick-disconnect fuel coupling.

The ability to accurately monitor and control the popping process permits the user to precisely adjust the parameters during the popping process. This element of control enables the user to make popcorn with less waste and more efficiency. Setting the temperature of the kettle corn popper to an optimal temperature for popping corn permits the user to make popcorn using about 60% of the energy of a typical machine.

Accordingly, it is a principal object of the invention to disclose a kettle corn popper that comprises a plurality of control instruments.

It is another object of the invention to introduce a kettle corn popper that includes a plurality of monitoring instruments.

It is a further object of the invention to disclose a kettle corn popper that comprises a quick-disconnect fuel supply fitting.

Still another object of the invention is to introduce a kettle corn popper that comprises stainless steel construction.

It is another object of the invention to disclose a kettle corn popper that includes a nonstick popping kettle.

It is another object of the invention to introduce a kettle corn popper that comprises an internal kettle-lifting linkage.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is a perspective view of the front and right side of a kettle corn popper according to the invention.

FIG. 2 is a perspective view of the back and left side of the kettle corn popper.

FIG. 3 is a side view of the left side of the kettle corn popper.

FIG. 4 is a front view of the open kettle corn popper.

FIG. 5 is a top view of the open kettle corn popper.

FIG. 6 is a side view of left side of the open kettle corn popper showing interior details.

FIG. 7 is a detail view of the control panel for the kettle corn popper.

Similar reference characters denote corresponding features consistently throughout the attached drawings.

### DETAILED DESCRIPTION OF THE PREFERRED EMBODIMENT

The present invention is a popcorn popper, more specifically a kettle corn popper. The kettle corn popper is comprised of a hemispherical popping bowl, a cabinet, a control panel, a plurality of controls, a plurality of indicators, a heating assembly, and a popping bowl lifting mechanism.

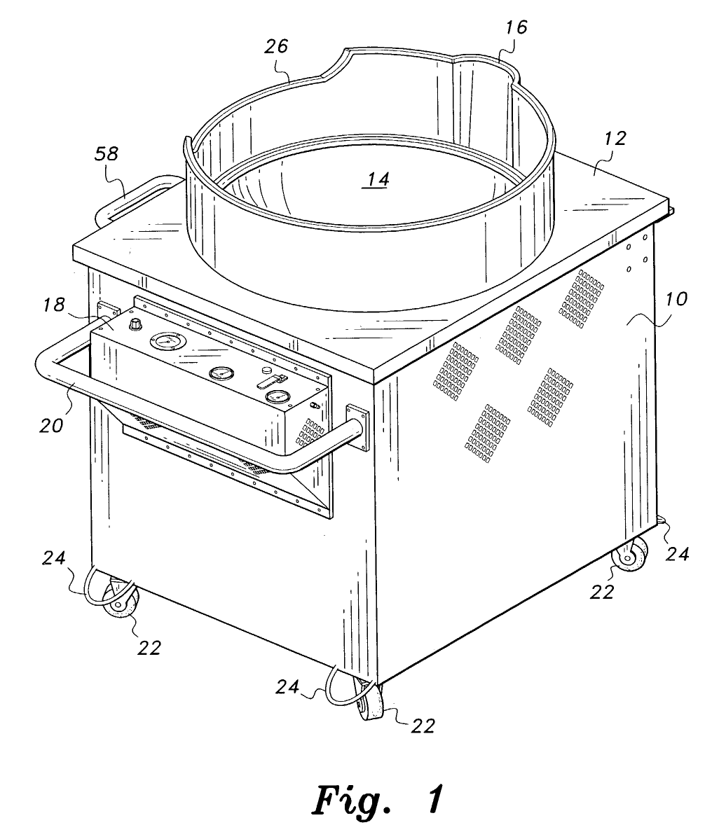

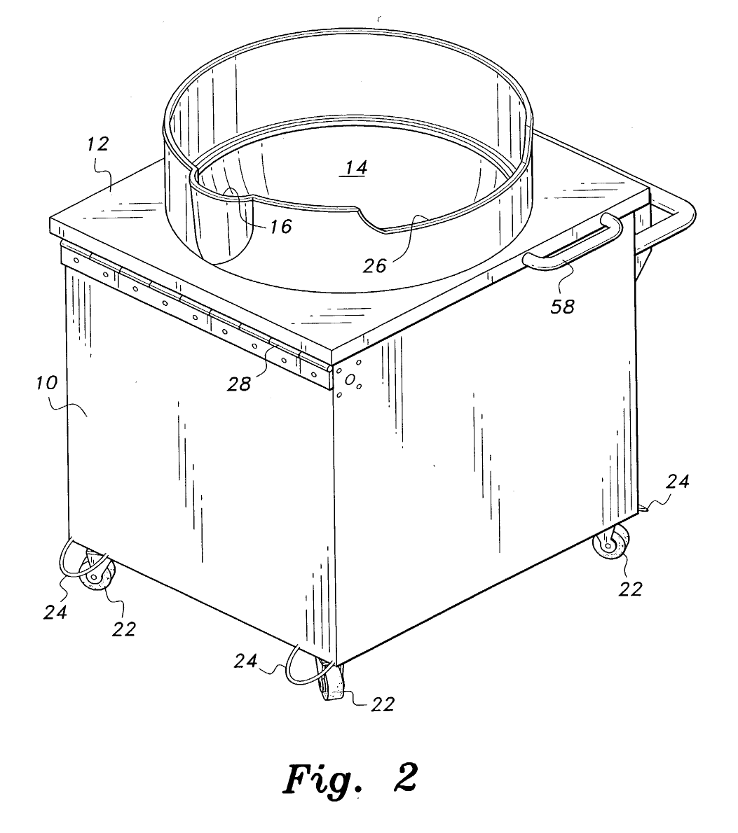

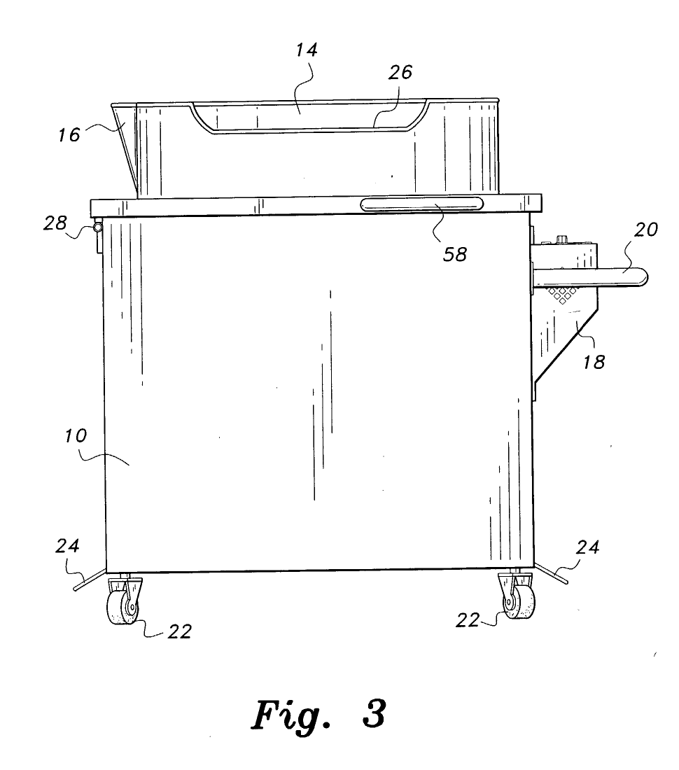

FIGS. 1, 2 and 3 are perspective views of the front and right side of the kettle corn popper, the back and left side of the kettle corn popper, and a side view of the left side of the kettle corn popper respectively. The cabinet 10 is a generally rectangular enclosure for the kettle corn popper. As shown in FIG. 2, a deck 12 is attached to the cabinet 10 with a hinge 28. The deck 12 includes a hemispherical kettle 14. In the preferred embodiment, the kettle 14 comprises a nonstick coating, and further comprises a spout 16 and a relieved lip 26. The spout 16 is an aid for directing the popped corn into a receiving vessel. The relieved lip 26 permits improved access to the kettle 14 by the user.

The cabinet 10 further comprises a control panel 18, for monitoring and controlling the popping process, and a handle 20. In the preferred embodiment, the cabinet 10 further includes a plurality of casters 22 and a plurality of tie-down loops 24. The plurality of casters 22 permit the user to easily roll the kettle corn popper to a desired location, and the plurality of tie-down loops 24 permit the user to secure the kettle corn popper to the desired location. In the preferred embodiment, the kettle corn popper is constructed of stainless steel.

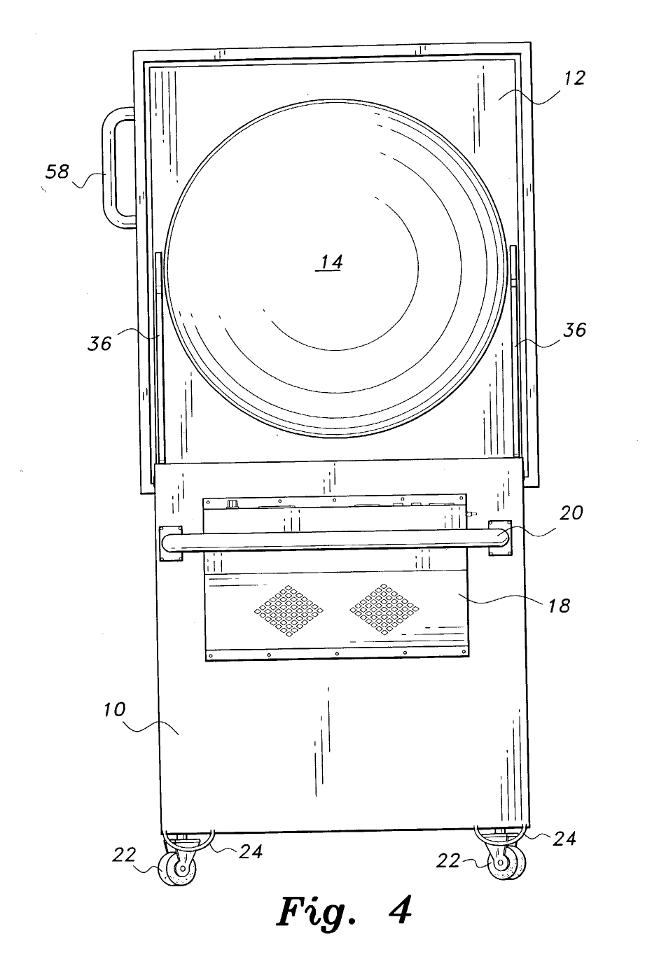

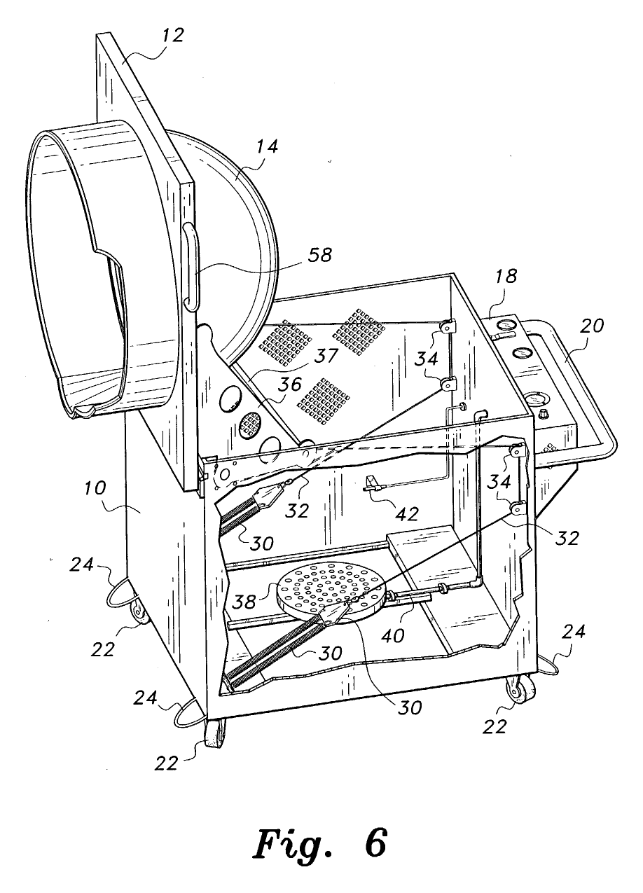

FIG. 4 is a front view of the open kettle corn popper. The deck 12 is fully raised and the bottom of the kettle 14 is visible. In this position, the user can dump a batch of popped corn into a receiving vessel. In the preferred embodiment, the deck 12 includes a deck handle 58 to provide a grasping surface for the user to lift the deck 12. A pair of lifting arms 36 are fixed to the deck 12. The lifting arms 36 are oriented in close proximity to the hinge 28 (not shown) and fixed to the underside of the deck 12. This provides a neat external appearance and the shape of the lifting arms 36 provides increased leverage for an internal lift mechanism (see FIG. 6). The result is that the deck 12 may be raised to the shown position without excessive effort. The neat external appearance provided by the internal lift mechanism yields a further benefit in that the moving parts are not a hazard to the user or other people in close proximity to the kettle corn popper. The internal lift mechanism also limits deck travel and holds the deck in a raised position.

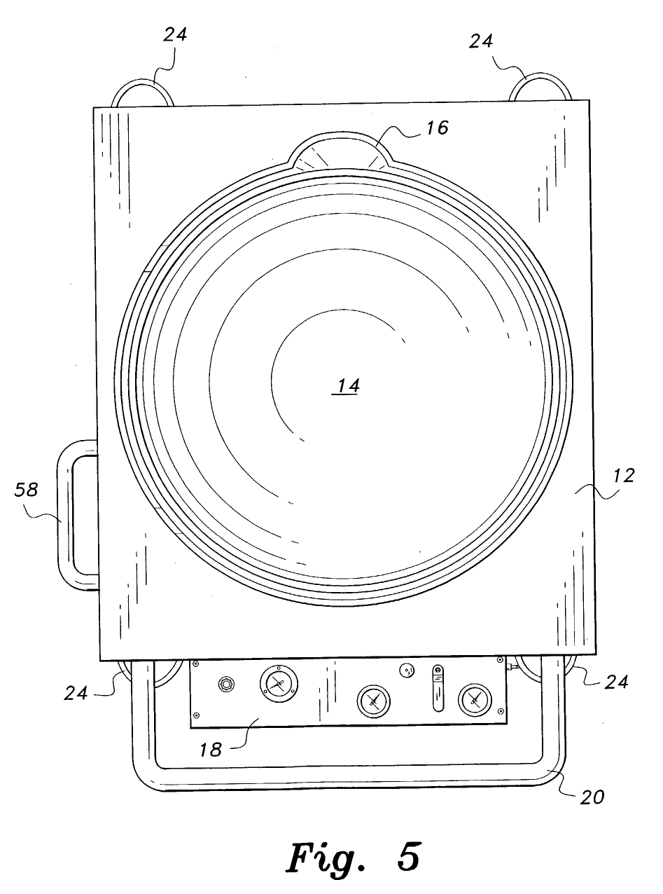

FIG. 5 is a top view of the kettle corn popper with the deck 12 in the fully lowered position. The kettle 14 is incorporated into the deck 12 to efficiently use the space available within the deck 12 and the cabinet 10. The control panel 18 is protected from damage by the handle 20, yet is easily accessible to the user.

FIG. 6 is a side view of left side of the open kettle corn popper showing interior details. The deck 12 is shown fully raised. The internal lift mechanism is comprised of a plurality of springs 30, and pair of yokes 31, a pair of cables 32, a plurality of pulleys 34, a pair of lift arms 36 and a reinforcement rod 37.

The lift arms 36 are a pair of generally triangular shaped pieces that are fixed to the under side of the deck 12. The lift arms 36 are oriented in a vertical plane so that their planar surfaces are parallel to and adjacent to the right side and left side of the cabinet 10. A reinforcement rod 37 is fixed between the pair of lift arms 36 at the point of each lift arm 36 farthest from the deck 12. The reinforcement rod 37 provides additional strength and rigidity to the lift arms 36.

A plurality of springs 30 is attached inside the bottom of the cabinet 10 near the junction of the back and each side of the cabinet 10. A pair of yokes 31 connect each of the plurality of springs 30 to one of a pair of cables 32. The pair of cables are routed through a plurality of pulleys 34 attached inside the cabinet 10 and connected to the reinforcement rod 37. The internal lift mechanism acts as a counterpoise to the weight of the deck 12 to reduce the effort required to lift the deck 12 and dump the contents of the kettle 14 into a receiving vessel. In the preferred embodiment, a plurality of springs 30 is used on each side of the cabinet 10.

A burner 38 is attached inside the bottom of the cabinet 10. A fuel line 40 is fixed to the burner 38 at one end and to a fuel pressure regulator 54 at the control panel 18. An electronic fuel igniter (not shown) is mounted immediately adjacent to the burner. A temperature sensor 42 is attached inside the cabinet 10 to receive temperature information which is displayed at the control panel 18.

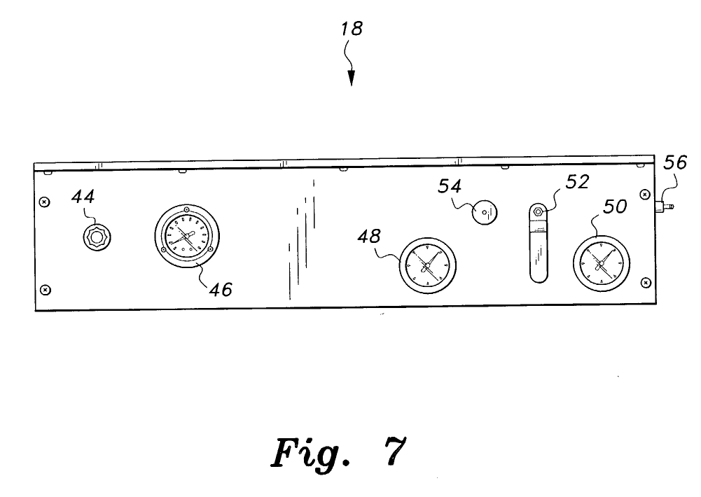

FIG. 7 is a detail view of the control panel 18 for the kettle corn popper. The control panel 18 is a single area devoted to the placement of control and monitoring instrumentation for the kettle corn popper. Control instrumentation includes an electronic igniter control 44, a fuel shutoff valve 52, a fuel pressure regulator 54 and a quick-disconnect fuel coupling 56. Other control instrumentation may include automatic temperature control. Monitoring instrumentation includes a temperature gauge 46, and a plurality fuel pressure gauges, or a single, multiplexed fuel pressure gauge. In the preferred embodiment, the plurality of fuel pressure gauges includes a post-regulator fuel pressure gauge 48 to measure the fuel pressure between the fuel pressure regulator 54 and the burner 38. The preferred embodiment further includes a pre-regulator fuel pressure gauge 50 to measure the fuel pressure between the main fuel supply and the fuel pressure regulator 54.

In the preferred embodiment, the control panel comprises instrumentation for monitoring or controlling the temperature inside the cabinet 10 including, a fuel pressure regulator 54, a pre-fuel regulator fuel pressure gauge 50, a post-fuel regulator fuel pressure gauge 48, an electronic igniter control 44, a fuel shutoff valve 52, and a quick-disconnect fuel coupling 56.

It is to be understood that the present invention is not limited to the embodiment described above, but encompasses any and all embodiments within the scope of the following claims.

I claim:

1. A kettle corn popper comprising:
a cabinet;
a deck attached to an upper edge of the cabinet;
hinge means for attaching the deck to the cabinet;
a hemispherical kettle fixed to the deck and protruding through the deck into the cabinet;
a control panel attached to the cabinet; and
a heating assembly attached inside the cabinet.

2. The kettle corn popper of claim 1, wherein the control panel comprises a plurality of control instrumentation.

3. The kettle corn popper of claim 2, wherein the plurality of control instrumentation on the control panel comprises:
a quick disconnect fuel coupling protruding from a side of the control panel;
an electronic igniter control mounted on an upper surface of the control panel;
a fuel shutoff valve mounted on the control panel; and
a fuel pressure regulator mounted on the control panel.

4. The kettle corn popper of claim 1, wherein the control panel comprises a plurality of monitoring instrumentation.

5. The kettle corn popper of claim 4, wherein the plurality of monitoring instrumentation on the control panel comprises:
a temperature gauge mounted in the control panel; and
a fuel pressure gauge mounted in the control panel.

6. The kettle corn popper of claim 5, wherein the plurality of monitoring instrumentation on the control panel comprises a plurality of fuel pressure gauges mounted in the control panel.

7. The kettle corn popper of claim 6, wherein the plurality of fuel pressure gauges comprises:
a pre-regulator fuel pressure gauge mounted in the control panel; and
a post-regulator fuel pressure gauge mounted in the control panel.

8. The kettle corn popper of claim 1, wherein the cabinet further comprises:
a handle fixed to a side of the cabinet;
a plurality of casters attached a bottom of the cabinet; and
a plurality of tie-down loops attached to the sides of the cabinet adjacent to the plurality of casters.

9. The kettle corn popper of claim 1, wherein the deck comprises a deck handle fixed along an edge of the deck opposite from the hinge.

10. The kettle corn popper of claim 1, wherein the kettle comprises:
a nonstick coating fixed to an interior surface of the kettle;
a spout formed into an upper edge of the kettle; and
a relieved lip formed from an upper edge of the kettle.

11. The kettle corn popper of claim 1, further comprising a deck lift mechanism attached to the deck and the cabinet.

12. The kettle corn popper of claim 11, wherein the deck lift mechanism is entirely concealed within the cabinet.

13. The kettle corn popper of claim 12, wherein the deck lift mechanism comprises:
a pair of lifting arms, wherein each lifting arm is a generally triangular brace attached along an edge to an underside of the deck in an area adjacent to the hinge so as to be coplanar to, and enclosed within, the cabinet's vertical walls when the deck is lowered upon the cabinet;
a reinforcing rod spanning and attached to the pair of lifting arms at the lifting arms' lowest point when the deck is lowered onto the cabinet;
a plurality of springs attached at a lower end to an interior of the cabinet;
a plurality of yokes attached to an upper end of the plurality of springs;
a plurality of pulleys mounted to the interior of the cabinet in an array generally coplanar with the lifting arms; and
a plurality of cables attached to the yokes at one end and the reinforcing rod at another end, wherein the plurality of cables are routed through the pulleys that are coplanar to the lifting arm that is closest to the yoke to which each of the plurality of cables is attached.

14. The kettle corn popper of claim 13, wherein the plurality of springs in the deck lift mechanism is four.

15. The kettle corn popper of claim 1, wherein the heating assembly comprises:
a burner mounted in the bottom of the cabinet;
an electronic fuel igniter attached adjacent to the burner; and
a fuel line attached to both the burner and to the fuel pressure regulator in the control panel.

16. The kettle corn popper of claim 15, wherein the burner comprises an adjustable air to fuel ratio.

17. The kettle corn popper of claim 1, further comprising stainless steel construction.

18. A kettle corn popper comprising:
a cabinet;
a deck attached to an upper edge of the cabinet by a hinge;
a hemispherical kettle fixed to the deck and protruding through the deck into the cabinet;
a deck lift mechanism attached to an underside of the deck and an interior of the cabinet wherein the deck lift mechanism is housed completely within the cabinet and under the deck;
a control panel attached to the cabinet wherein the control panel comprises a plurality of monitoring and control instruments; and
a heating assembly attached inside the cabinet.

19. A kettle corn popper comprising:
a cabinet;
a deck attached to an upper edge of the cabinet by a hinge;
a hemispherical kettle fixed to the deck and protruding through the deck into the cabinet;
a deck lift mechanism attached to an underside of the deck and an interior of the cabinet wherein the deck lift mechanism is housed completely within the cabinet and under the deck; and
a heating assembly attached inside the cabinet.

20. The kettle corn popper of claim 19, wherein the deck lift mechanism further comprises:
a deck travel limiter; and
a deck lock.
